(19) United States
(12) Patent Application Publication
(10) Pub. No.: US 2010/0043007 A1
(43) Pub. Date: Feb. 18, 2010

(54) MOBILE APPARATUS, A METHOD OF CONTROLLING A RATE OF OCCUPATION OF A RESOURCE OF A CPU

(75) Inventor: Toshiaki MURANAKA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/406,593

(22) Filed: Mar. 18, 2009

(30) Foreign Application Priority Data
Aug. 12, 2008 (JP) P2008-208180

(51) Int. Cl. G06F 9/50

(52) U.S. Cl. 718/104

(57) ABSTRACT

Provided is a mobile apparatus capable of stably executing an animating process even if an interrupting process occurs during execution of the animating process. The device includes a single CPU configured to execute the animating process at least including reproduction and recording of animated images in parallel with execution of a process other than the animating process and a resource control unit configured to control, in the case that an interruptive event occurs while the CPU is executing the animating process and the CPU executes the interrupting process simultaneously with occurrence of the interruptive event, the rate of occupation of a CPU resource allocated to execution of the interrupting process.

### BACKGROUND OF THE INVENTION

1. Field of the Invention

The present invention relates to a mobile apparatus, and more particularly to a mobile apparatus provided with a single CPU for executing an animating process including reproduction and recording of animated images in parallel with execution of a process other than the animating process.

2. Description of the Related Art

Recently, mobile apparatuses having a function of receiving a broadcast via One Segment Broadcasting to allow a user to view it and recording the received broadcast, and a function of reproducing animated image data using a data communication service have been widely used.

As one of these mobile apparatuses mentioned above, a mobile apparatus provided with a CPU dedicated to execution of an animating process, in addition to a CPU for generally controlling the mobile apparatus is well known. FIG. 6A is a diagram showing main hardware structures of a mobile apparatus 60a provided with a CPU 61a and a CPU 62 dedicated to execution of the animating process.

The CPU 62 dedicated to execution of the animating process shown in FIG. 6A realizes high speed execution of an animating process such as an animated image reproducing and recording process and further realizes effective execution of the animating process by being used together with the CPU 61a.

In contrast, a mobile apparatus for executing all processes including the animating process by using a single CPU is also well known. FIG. 6B is a diagram showing main hardware structures of a mobile apparatus 60b provided with a single CPU 61b. As shown in FIG. 6B, processes of the mobile apparatus 60b are executed by the single CPU 61b with no provision of the CPU 62 dedicated to execution of the animating process, by which the production cost of the mobile apparatus 60b can be reduced and size reduction and weight reduction can be also realized.

Note that FIGS. 6A and 6B only shows a memory 63, a One Segment Broadcasting receiving unit 64, a One Segment Broadcasting antenna 65 and a display 66 constituting the main hardware structures of the mobile apparatus 60a and 60b and other structures are omitted for convenience of explanation.

However, a problem occurs that in the case that an interrupting process occurs while the animating process is being executed, the load on the CPU 61b is increased and hence stable environment for execution of the animating process cannot be obtained in that scene missing occurs upon reproduction of animated images.

In view of the above, there has been proposed a technique capable of avoiding an unintended interrupting process in advance to stably execute contents processing as disclosed, for example, in Japanese Unexamined Patent Application Publication No. 2007-243569.

The technique disclosed in Japanese Unexamined Patent Application Publication No. 2007-243569 prevents scene missing and noise superposition which would occur while the contents are being reproduced by temporarily laying aside a communication mode in the case that the bit rate of the contents to be reproduced exceeds a predetermined bit rate.

However, for a user of a mobile apparatus, it is most desirable that the interrupting process be executed with no occurrence of scene missing of animated images even while the animated images are being reproduced or recorded and in parallel with reproduction or recording of these animated images. In particular, in some cases, urgent reception of an electronic mail is needed depending on its contents and it is not favorable for the user to routinely leave an electronic mail receiving process on standby until the animating process is completed.

### SUMMARY OF THE INVENTION

The present invention has been conceived of in view of the above mentioned circumstances. Accordingly, it is one object of the present invention to provide a mobile apparatus and a method of controlling a rate of occupation of a resource of a CPU capable of stably executing an animating process even in the case that an interrupting process occurs while the animating process is being executed.

It is another object of the present invention to provide a mobile apparatus capable of favorably executing the interrupting process occurring while the animating process is being executed in parallel with execution of the animating process.

In order to solve the above mentioned problems, according to the present invention, there is provided a mobile apparatus including: a single CPU configured to execute an animating process at least including reproduction and recording of animated images in parallel with execution of a process other than the animating process; and a resource control unit configured to control, in the case that an interruptive event occurs while the CPU is executing the animating process and the CPU executes an interrupting process simultaneously with occurrence of the interruptive event, a rate of occupation of a resource of the CPU allocated to execution of the interrupting process.

The mobile apparatus of the above aspect may further including a judging unit configured to judge a contents of the interrupting process to be executed simultaneously with occurrence of the interruptive event if the interruptive event occurs while the CPU is executing the animating process, wherein the resource control unit controls the rate of occupation of the CPU resource allocated to execution of the interrupting process in accordance with the contents thereof judged by the judging unit.

A method of controlling a rate of occupation of a resource of a CPU, comprising the steps of: preparing a single CPU configured to execute an animating process at least including reproduction and recording of animated images in parallel with execution of a process other than the animating process; and controlling the rate of occupation of the resource of the CPU allocated to execution of an interrupting process in the case that an interruptive event occurs while the CPU is executing the animating process, and the CPU executes the interrupting process simultaneously with occurrence of the interruptive event.

The method of the above aspect may further comprises: judging a contents of the interrupting process to be executed simultaneously with occurrence of the interruptive event if the interruptive event occurs while the CPU is executing the animating process, wherein the step of controlling comprises: controlling the rate of occupation of the CPU resource allocated to execution of the interrupting process in accordance with the contents of the interrupting process.

The mobile apparatus according to the present invention is capable of stably executing an animating process even if an interrupting process occurs during execution of the animating process.

### BRIEF DESCRIPTION OF THE DRAWINGS

FIGS. 1A and 1B are diagrams showing one external structure of a mobile phone showing an embodiment of a mobile apparatus of the present invention;

FIGS. 2A and 2B are diagrams showing another external structure of the mobile phone showing the embodiment of the mobile apparatus of the present invention;

FIG. 3 is a diagram showing an internal structure of the mobile phone according to the embodiment of the present invention;

FIG. 4A is a graph showing transition with time of the rate of occupation of a CPU resource obtained when a control unit has not executed a resource controlling process, and FIG. 4B is a graph showing transition with time of the rate of occupation of the CPU resource obtained when the control unit has executed the resource controlling process;

FIG. 5 is a flowchart illustrating a resource controlling process executed upon occurrence of an interrupting process executed by the mobile phone according to the embodiment;

FIG. 6A is a diagram showing main hardware structures of one known mobile apparatus provided with one CPU and another CPU dedicated to execution of an animating process, and FIG. 6B is a diagram showing main hardware structures of another known mobile apparatus provided with a single CPU.

### DETAILED DESCRIPTION OF THE PREFERRED EMBODIMENT

A preferred embodiment of a mobile apparatus and a method of controlling a rate of occupation of a resource of a CPU according to the present invention will be described with reference to the accompanying drawings.

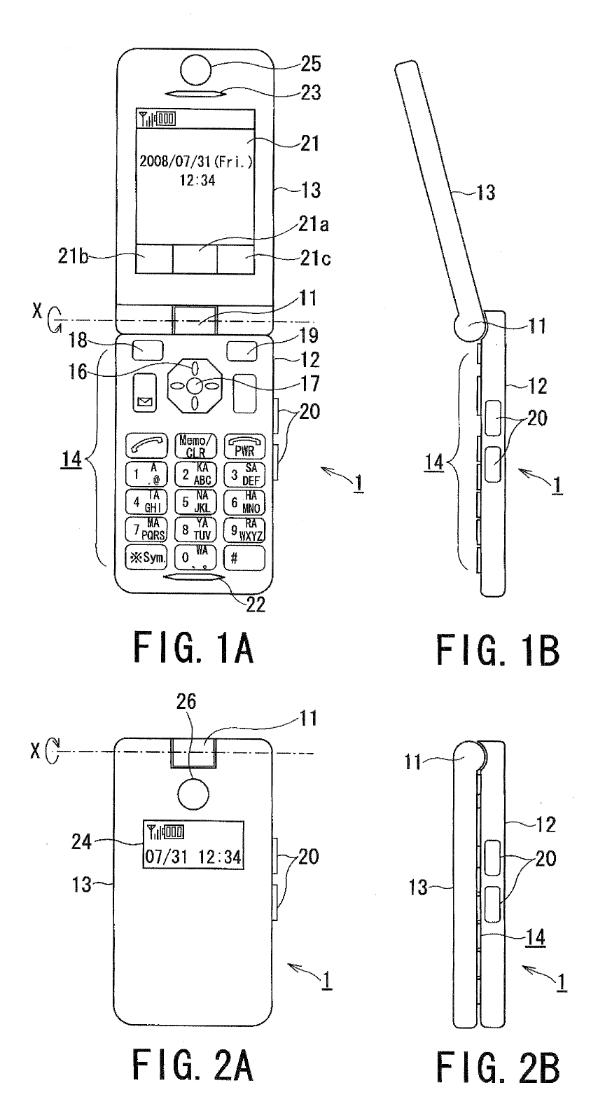

FIGS. 1A and 1B are diagrams showing one external structure of a mobile phone according to an embodiment of a mobile apparatus of the present invention. FIG. 1A shows the external structure viewed from the front when a mobile phone 1 is opened to an angle of about 180° and FIG. 1B shows the external structure viewed from the right side of the mobile phone 1 in an open state.

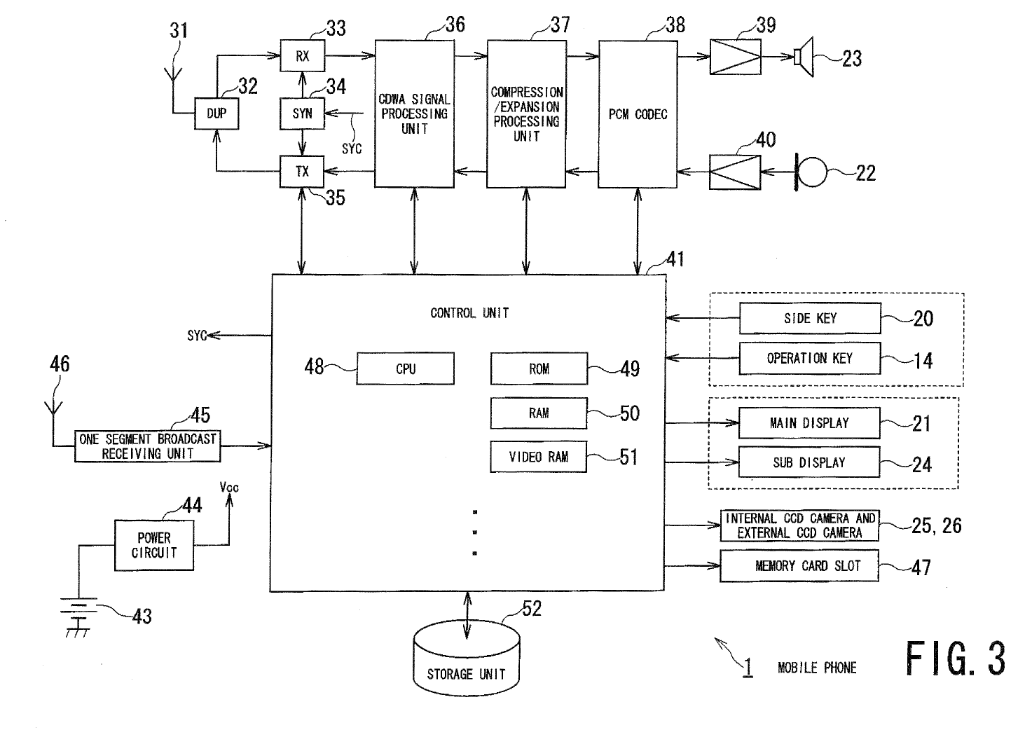

As shown in FIGS. 1A and 1B, in the mobile phone 1, a first housing 12 and a second housing 13 are hinged together bordering on a hinge part 11 so as to be foldable in a direction shown by an arrow X via the hinge part 11. An antenna (an antenna 31 which will be described later with reference to FIG. 3) for transmission/reception use is disposed in a predetermined position within the mobile phone 1 and radio waves are transmitted/received to/from the mobile phone to a base station (not shown) via the antenna built into the mobile phone 1.

Operation keys 14 such as numeral keys from “0” to “9”, a call/response key, a redial key, a hold/power key, a clear key and a menu key are installed on the surface of the first housing 12. Various instructions can be input by using these operation keys 14.

A cross key 16 and a decision key 17 are installed on an upper part of the first housing 12 as the operation keys 14. The cross key 16 is constituted by an up key, a down key, right key and a left key such that a user can operate the cross key 16 up, down, right or left to move a cursor displayed on a main display 21 up, down, right or left. In addition, the user can decide to perform various functions by depressing the decision key 17. In addition, execution of a process displayed on a decision key function display unit 21a installed on a lower part of the main display 21 is allocated to the decision key 17.

Further, on the first housing 12, a left soft key 18 and a right soft key 19 are installed respectively above the cross key 16 and the decision key 17. Side keys 20 for operating the mobile phone 1 are installed on a side of the first housing 12. Execution of a predetermined process allocated to each of the left soft key 18, the right soft key 19 and the side keys 20 is performed by pressing the key downward into the first housing 12. In particular, processes indicated on a left soft key function display unit 21b and a right soft key function display unit 21c installed on lower parts of the main display 21 are executed using the left soft key 18 and the right soft key 19.

On the first housing 12, a microphone 22 is installed under the operation keys 14 so as to pick up the voice of the user who is on the phone using the microphone 22.

A battery pack, not shown, is embedded in the first housing 12 on its rear side. When a hold/power key is depressed to turn on the power source, power is supplied from the battery pack to each circuit component to put the circuit components into an operable state.

On the other hand, the main display 21 is installed on the front of the second housing 13 so as to display various information such as a radio wave receiving state, the battery residue, the contents of an electronic mail and a simplified homepage. The main display 21 is constituted by, for example, an LCD (Liquid Crystal Display), an organic EL (Electro Luminescence) display, or an inorganic EL display.

An internal CCD camera 25 is installed on an upper part of the second housing 13 so as to take static images and animated images of a desired photographic subject.

In addition, a receiver 23 is installed in a predetermined position above the main display 21, through which the user can talk over the phone using his/her voice. Incidentally, in a predetermined position on the mobile phone 1, there is also installed a loudspeaker (not shown) as a voice outputting unit other than the receiver 23. Upon communication via video-telephones, the voice of a called party is output from this loudspeaker.

FIG. 2A and FIG. 2B are diagrams showing another external structure of the mobile phone 1 according to the embodiment of the mobile apparatus of the present invention. The mobile phone 1 shown in FIG. 2A and FIG. 2B is in a closed state obtained by rotating the mobile phone 1 shown in FIG. 1 in the direction shown by the arrow X. FIG. 2A shows the closed external structure of the mobile phone 1 viewed from the front and FIG. 2B shows the closed external structure thereof viewed from the right side.

An external CCD camera 26 is installed on an upper part of the second housing 13, through which static images and animated images of a desired photographic object can be taken as in the case with the internal CCD camera 25.

Under the external CCD camera 26, a sub display 24 constituted by, for example, an LCD is installed to display an antenna pictograph indicative of the current sensitivity level of the antenna, a battery pictograph indicative of the current battery residue of the mobile phone 1 and the current time.

FIG. 3 illustrates an inner configuration of the mobile phone 1 which can be applied to the mobile apparatus according to the embodiment of the present invention. A radio signal transmitted from the base station is received by the antenna 31, and thereafter input to a reception circuit (RX) 33 via an antenna duplexer (DUP) 32. The reception circuit 33 may perform mixing of the received radio signal with a local oscillator signal output from a frequency synthesizer (SYN) 34. The reception circuit 33 down-convert a frequency conversion to generate an intermediate frequency signal. Then, the reception circuit 33 performs a quadrature demodulation (quadrature detection) on this down-converted intermediate frequency signal to output a reception baseband signal. It should be noted that the frequency of the local oscillator signal generated from the frequency synthesizer 34 is instructed on the basis of a control signal SYC output from a control unit 41.

The reception baseband signal from the reception circuit 33 is input to a CDMA signal processing unit 36. The CDMA signal processing unit 36 is provided with a RAKE receiver which is not shown in the drawing. In this RAKE receiver, a plurality of paths included in the reception baseband signal are subjected to a despreading processing with the respective spread codes (that is, the same spread code as the spread code of the spread reception signal). Then, after the phase is adjusted, the despread signal of the respective paths is coherently RAKE combined by a coherent RAKE combiner which is not shown. The data series after the Rake combining is subjected to deinterleave and channel decoding (error correction decoding), and thereafter a binary data determination is carried out. With this configuration, it is possible to obtain reception packet data with use of a predetermined transmission format. This reception packet data is input to a compression/expansion processing unit 37.

The compression/expansion processing unit 37 is composed of a DSP (Digital Signal Processor). The compression/expansion processing unit 37 may separate the reception packet data output from the CDMA signal processing unit 36 in a multiple separation unit which is not shown for each media, and perform a decoding processing on the separated data for each media.

For example, in the conversation mode, speech data corresponding to the conversation voice or the like included in the reception packet data is decoded by way of speech codec. Also, for example, in case of a television telephone mode, when motion picture data is included in the reception packet data, this motion picture data is decoded by way of video codec. Furthermore, when the reception packet data is a download content, after this download content is expanded, the expanded download content is output to the control unit 41.

The digital speech signal obtained through the decoding processing is supplied to a PCM codec 38. The PCM codec 38 may perform a PCM decoding on the digital speech signal output from the compression/expansion processing unit 37 and output the analog speech data after the PCM decoding to a receiver amplifier 39. This analog speech signal is amplified by the call receiver amplifier 39 and thereafter output from the receiver 18.

The digital motion picture signal decoded by way of the video codec through the compression/expansion processing unit 37 is input to the control unit 41. The control unit 41 displays the motion picture based on the digital motion picture signal output from the compression/expansion processing unit 37 on the main display 21 via a video RAM (for example, a VRAM or the like) which is not shown. It should be noted that the control unit 41 can display not only the received motion picture data but also the motion picture data picked up by the internal and external CCD camera 25, 26 on the main display 21 via the video RAM.

Also, in a case where the reception packet data is the electronic mail, the compression/expansion processing unit 37 supplies this electronic mail to the control unit 41. The control unit 41 instructs a storage unit 52 to store the electronic mail supplied from the compression/expansion processing unit 37. Then, in accordance with the operation by the user on the operation keys 14 as the input unit, the control unit 41 reads out this electronic mail stored in the storage unit 52 and displays the read electronic mail on the main display 21.

On the other hand, in the conversation mode, the speech signal (analog speech signal) of the speaker (user) which is input to the microphone 22 is amplified to an appropriate level by a transmitter amplifier 40, and then PCM-encoded by the PCM codec 38. The digital speech signal after the PCM encoding is input to the compression/expansion processing unit 37. Also, the motion picture signal output from the internal and external CCD camera 25, 26 is digitalized by the control unit 41 to be input to the compression/expansion processing unit 37. Furthermore, the electronic mail as text data which is generated in the control unit 41 is also input to the compression/expansion processing unit 37.

The compression/expansion processing unit 37 may perform a compression encoding on the digital speech signal output from the PCM codec 38 in a format in accordance with a predetermined transmission data rate. With this configuration, the speech data is generated. Also, the compression/expansion processing unit 37 performs a compression encoding on the digital motion picture signal output from the control unit 41 to generate the motion picture data. Then, the compression/expansion processing unit 37 multiplexes the speech data and the motion picture data in the multiple separation unit in accordance with a predetermined transmission format, and packetizes the data. After that, the compression/expansion processing unit 37 outputs the transmission packet data after the packetization to the CDMA signal processing unit 36. It should be noted that also in a case where the electronic mail is output from the control unit 41, the compression/expansion processing unit 37 multiplexes this electronic mail into the transmission packet data.

The CDMA signal processing unit 36 may use a spread code allocated to the transmission channel to perform a spread spectrum processing on the transmission packet data output from the compression/expansion processing unit 37. Then, the CDMA signal processing unit 36 outputs the output signal after the spread spectrum processing to a transmission circuit (TX) 35. The transmission circuit 35 modulates the signal after the spread spectrum processing by using a digital modulation system such as a QPSK (Quadrature Phase Shift Keying) method. The transmission circuit 35 synthesizes the transmission signal after the digital modulation with the local oscillator signal generated from the frequency synthesizer 34 to perform a frequency conversion (up convert) on the radio signal. Then, the transmission circuit 35 performs a high frequency amplification on the radio signal generated through this up convert so as to obtain the transmission power level which is instructed by the control unit 41. This wireless signal having been subjected to the high frequency amplification is supplied to the antenna 31 via the antenna duplexer 32 and transmitted from the antenna 31 to the base station.

A power supply circuit 44 generates a predetermined operating supply voltage Vcc from an output from a battery 43 to be supplied to each circuit component.

A One Segment Broadcast receiving unit 45 receives a television signal corresponding to a desired channel from a broadcast signal (via One Segment Broadcasting) received via a One Segment Broadcast antenna 46. The One Segment Broadcast receiving unit 45 is also capable of receiving a radio broadcast.

A memory card slot 47 has a slot into which a memory card can be detachably inserted. The memory card is a kind of flash memory card represented by NAND type flash memory cards and NOR type flash memory cards and various data such as images, speech and music can be written into the memory card and read out from the memory card via a 10-pin terminal The control unit 41 is constituted by a CPU (Central Processing Unit) 48, a ROM (Read Only Memory) 49 and a RAM (Random Access Memory) 50. The CPU 48 executes various processes in accordance with programs stored in the ROM 49 or various application programs loaded from a storage unit 52 to the RAM 50, and generates various control signals and supplies these control signals to respective units to generally control the mobile phone 1. Incidentally, the mobile phone 1 according to this embodiment is provided with the single CPU 48 for executing the animating process in parallel with execution of a process or more other than the animating process. In addition, the CPU 48 executes respective animating processes such as a process of reproducing and recording a broadcast via One Segment Broadcasting received by the One Segment Broadcast receiving unit 45, processes of reproducing animated images taken by the internal CCD camera 25 and the external CCD camera 26, a process of reproducing animated image data down-loaded using data transmission service and stored in the storage unit 52 or the memory card, and a process of reproducing animated images using streaming.

The RAM 50 appropriately stores data required for execution of various processes by the CPU 48. The control unit 41 also includes a video RAM 51 for temporarily storing information on video images to be displayed on the main display 21 and the sub display 24.

The storage unit 52 is constituted by, for example, a flash memory element or a HDD (Hard Disc Drive), that is, a nonvolatile memory capable of electrically rewriting and deleting data and stores various application programs executed by the CPU 48 of the control unit 41 and various data groups.

Here, in the case that an interruptive event of priority higher than that of the animating process occurs during execution of the animating process such as reproduction or recording of animated images and an interrupting process is to be executed at the same time as this interruptive event, the control unit 41 of the mobile phone 1 according to this embodiment of the present invention executes a resource controlling process for controlling the rate of occupation of a resource of the CPU 48 allocated to execution of the interrupting process. That is, the control unit 41 reduces the occupation rate of the CPU resource allocated to execution of the interrupting process and allocates a sufficient amount of the CPU resource required for execution of the animating process to execution of the animating process, thereby maintaining environment in which the animating process can be stably executed.

Owing to the above mentioned arrangement, even in the case that while an animating process is being executed, an interrupting process is to be executed in parallel therewith in the mobile phone 1 provided with the single CPU 48, there can be realized an environment in which the animating process can be stably executed with no occurrence of a scene missing phenomenon upon reproduction of animated images.

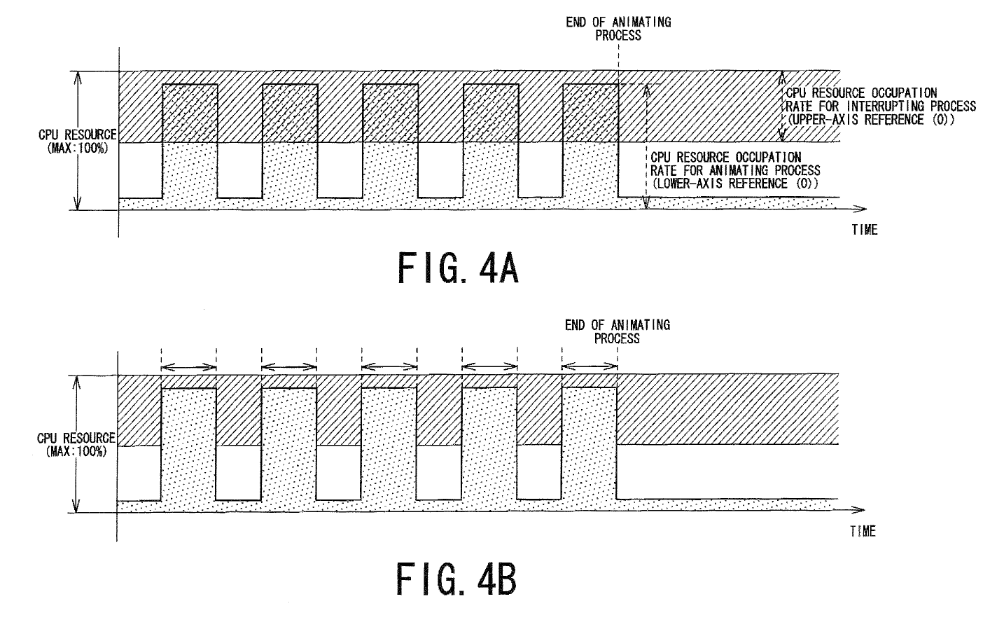

FIG. 4A is a graph showing transition with time of the occupation rate of the CPU resource obtained when the control unit 41 does not execute a resource controlling process. FIG. 4B is a graph showing transition with time of the occupation rate of the CPU resource obtained when the control unit 41 of the mobile phone 1 according to the embodiment has executed the resource controlling process. In these graphs, the vertical axis indicates the CPU resource with 100% set as the maximum value and the horizontal axis indicates the time. The CPU resource for execution of the animating process is indicated by a lower-axis reference (0%) and the CPU resource for execution of the interrupting process is indicated by an upper-axis reference (0%).

As shown in FIG. 4A, in the case that the control unit 41 does not execute the resource controlling process, part of the CPU resource allocated to execution of the animating process to be executed by the CPU 48 is allocated to execution of an interrupting process, occurring simultaneously with the interrupting process of higher priority. As a result, the CPU resource required for execution of the animating process lacks and the scene missing phenomenon occurs upon reproduction of animated images.

On the other hand, in the case that the control unit 41 has executed the resource controlling process as shown in FIG. 4B, controlling is performed to reduce the CPU resource allocated to execution of the interruptive event so as to maintain the occupation rate of the CPU resource required for stable execution of the animating process. Specifically, in the case that the CPU resource required for execution of the interrupting process conflicts with the CPU resource required for execution of the animating process, the control unit 41 controls the occupation rate of the CPU resource such that a sufficient amount of the CPU resource required for stable execution of the animating process be allocated to execution of the animating process. That is, the control unit 41 executes the resource controlling process in accordance with a timing at which the CPU resource required for execution of the animating process is normally lacking due to execution of the interrupting process so as to allot the CPU resource of the amount which had been originally allocated to execution of the interrupting process to execution of the animating process. At that time, the residue of the CPU resource allocated to execution of the animating process is allocated to execution of the interrupting process and the interrupting process is executed using the residue.

In the case that the interrupting process is still being continuously executed at the completion of the animating process, the control unit 41 completes the resource controlling process for reducing the occupation rate of the CPU resource allocated to execution of the interrupting process so as to allocate the usual occupation rate of the CPU resource to execution of the interrupting process.

Next, a specific resource controlling process executed by the control unit 41 upon occurrence of an interruptive event will be described. The resource controlling process executed upon occurrence of the interruptive event is a process of automatically discriminating the contents of an interrupting process to be executed simultaneously with occurrence of the interruptive event to control the occupation rate of the CPU resource allocated to execution of the interrupting process by the CPU 48.

Specifically, in the case that the interrupting process causes trouble in execution of the animating process, the animating process is preferentially executed and then the occupation rate of the interrupting process to be executed by the CPU 48 is reduced to execute the interrupting process at this reduced rate. On the other hand, in the case that the interrupting process is to be executed urgently, the occupation rate which had been originally allocated to execution of the interrupting process is maintained to execute the interrupting process in a short time period even though the environment in which the animating process is executed may become unstable.

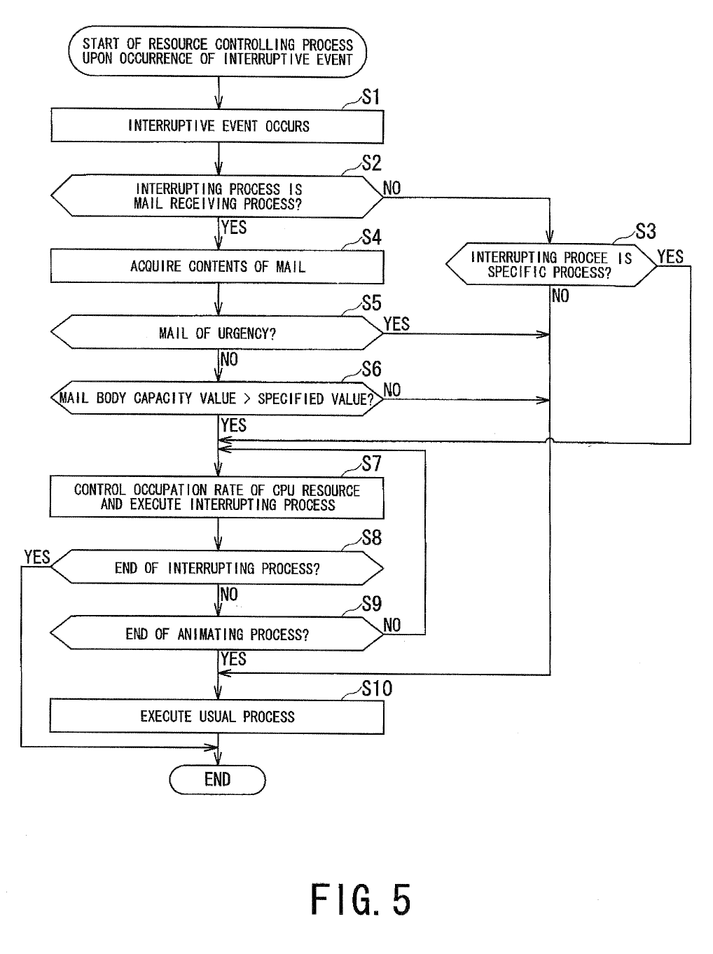

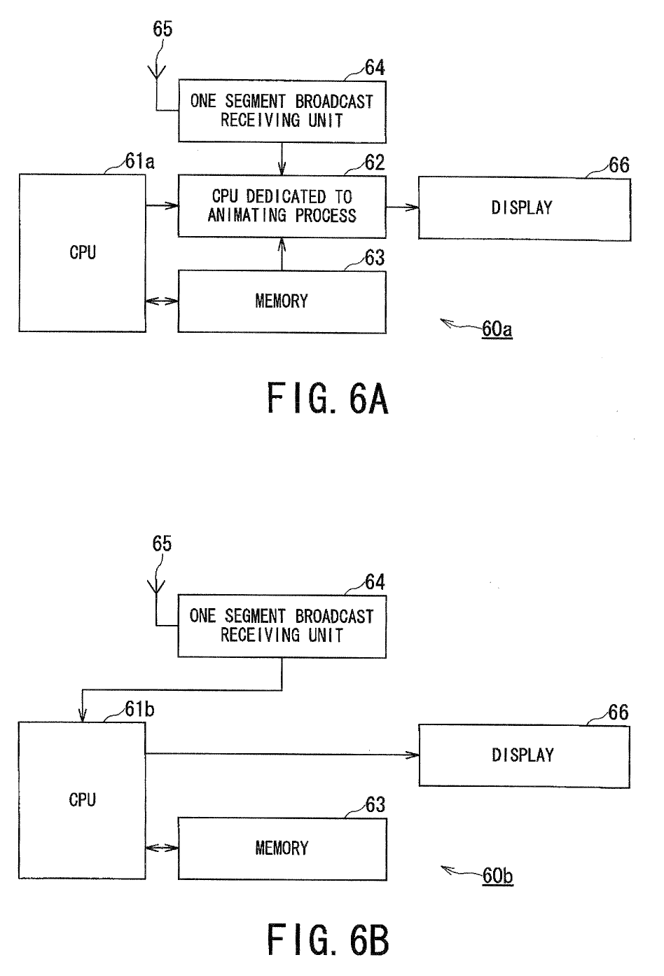

Next, the resource controlling process to be executed by the control unit 41 upon occurrence of the interruptive event will be described with reference to a flowchart. FIG. 5 shows the flowchart for illustrating the resource controlling process executed upon occurrence of the interruptive event by the mobile phone 1 according to the embodiment of the present invention.

This resource controlling process is started when the animating process such as the process of reproducing and recording the broadcast via One Segment Broadcasting received by the One Segment Broadcast receiving unit 45, the processes of reproducing the animated images taken by the internal CCD camera 25 and the external CCD camera 26, or the process of reproducing the animated image data downloaded using a data communication service and stored in the storage unit 52 or the memory card is being executed by the CPU 48 and when a certain interruptive event occurs.

Incidentally, the control unit 41 according to this embodiment functions as a resource control unit for controlling the occupation rate of the CPU resource allocated to execution of the interrupting process using the CPU 48 and a judging unit for judging the contents of the interrupting process to be executed simultaneously with occurrence of the interruptive event. The control unit 41 also functions as an urgency judging unit for judging urgency of an electronic mail received and a capacity value judging unit for judging whether a capacity value of the body of the electronic mail exceeds a predetermined specified value. In addition, for example, the storage unit 52 functions as a memory unit for storing a specific process. Incidentally, the specific process refers to a process of generating the shortage of the CPU resource required for execution of the animating process in the case that the CPU 48 has executed the animating process in parallel with execution of the process other than the animating process.

At step S1, the control unit 41 detects a certain interruptive event which has occurred in the mobile phone 1.

At step S2, the control unit 41 judges whether the interrupting process to be executed simultaneously with occurrence of the interruptive event is a process of receiving an electronic mail from an electronic mail server. At step S3, in the case that it is judged that the interrupting process is not the electronic mail receiving process, the control unit 41 judges whether the interrupting process is a specific process. The specific process means a process of generating the scene missing phenomenon by generating shortage of the CPU resource required for execution of the animating process. As the specific process, there can be conceived of, for example, a process executed when the contents of large capacity is downloaded by pushing. This specific process may be prepared in advance as data inherent to the mobile phone 1 or a process that the user wishes to execute preferentially to execution of the animating process may be prepared so as to be optionally settable as the specific process. In the case that the interrupting process is judged to be the specific process, the process proceeds to step S7 to execute the interrupting process which will be described later. On the other hand, in the case that the interrupting process is judged to be a process other than the specific process, the process proceeds to step S10 to execute a usual process which will be described later.

In the case that the interrupting process is judged to be a process of receiving the electronic mail at step S2 for judgment of the interrupting process, the control unit 41 acquires the contents of the electronic mail at step S4. The control unit 41 receives, for example, the header of the electronic mail and receives the address of the source of the electronic mail, the contents of its title and its degree of importance as the contents of the electronic mail from this header.

At step S5, the control unit 41 judges whether the electronic mail to be received is of urgency from the contents of the electronic mail. The electronic mail is of urgency in the case that the address which is set in advance to give priority to notification of reception of the mail is the address of the source from which the mail has been transmitted, in the case that the control unit 41 collates the title with a keyword indicative of urgency which has been registered in advance in the mobile phone 1 and judges that the keyword is included in the title or in the case that the degree of importance given to the electronic mail is set to a “high” level. In the case that the electronic mail is judged to be of urgency, the process proceeds to step S10 to execute the usual process which will be described later.

On the other hand, in the case that the electronic mail is judged to be of no urgency, the control unit 41 judges whether the capacity value of the body of the electronic mail exceeds a specified value at step S6. In the case that the control unit 41 judges that the capacity value of the body of the electronic mail is smaller than the specified value, the process proceeds to the step S10 to execute the usual process which will be described later.

On the other hand, in the case that the capacity value of the body of the electronic mail is judged to exceed the predetermined specified value, the control unit 41 controls the occupation rate of the CPU resource allocated to execution of the interrupting process to execute the interrupting process at the controlled rate at step S7. Specifically, as shown in FIG. 4B, the control unit 41 controls the occupation rate of the CPU resource so as to allocate a sufficient amount of the CPU resource required for stable execution of the animating process to execution of the animating processing. That is, the control unit 41 executes the resource controlling process in accordance with the timing at which the CPU resource required for execution of the animating process is normally lacking due to execution of the interrupting process so as to allot an amount of the CPU resource originally allocated to execution of the interrupting process to execution of the animating process. At that time, the residue of the CPU resource allocated to execution of the animating process is allocated to execution of the interrupting process and the interrupting process is executed using the residue.

In the case that the interrupting process is the electronic mail receiving process, the control unit 41 receives the electronic mail. However, in the case that the electronic mail has an attached file, only the body of the electronic mail may be received and the attached file may be received at the completion of execution of the animating process, because, in general, the capacity of the attached file is larger than that of the body of the electronic mail and hence reception of the file makes execution of the animating process unstable. At that time, the control unit 41 functions as an attachment judging unit for judging whether the electronic mail received by the receiving unit has an attached file.

At step S8, the control unit 41 judges whether the interrupting process is completed. In the case that the interrupting process is judged to be completed, the control unit 41 completes the resource controlling process executed upon occurrence of the interruptive event.

In the case that it is judged that the interrupting process is not yet completed, the control unit 41 judges whether the animating process has been completed at step S9. In the case that it is judged that the animating process is not yet completed, the control unit 41 returns to step S7 for executing the interrupting process to repeat the succeeding processes.

On the other hand, in the case that the animating process is judged to be completed, the control unit 41 completes the process of reducing the occupation rate of the CPU resource allocated to execution of the interrupting process and allocates the usual occupation rate of the CPU resource to execution of the interrupting process at step S10. Incidentally, a process which is executed without controlling the occupation rate of the CPU resource is called the usual process.

The mobile phone 1 according to the embodiment of the present invention, even in the case that there is provided a single CPU for executing the animating process in parallel with execution of a process other than the animating process, occurrence of a scene missing phenomenon can be prevented to realize stable execution of the animating process. In addition, since the occupation rate of a CPU resource is controlled in accordance with the contents of an interrupting process, imprudent reduction of the CPU resource allocated to execution of the interrupting process and delay of execution of the interrupting process due to the resource reduction can be avoided. In particular, in the case that the interrupting process is an electronic mail receiving process, whether the electronic mail is of urgency is automatically judged from the contents of the electronic mail, and in the case that the electronic mail is judged to be of urgency, the electronic mail receiving process is promptly executed, so that no trouble occurs for a user.

That is, an appropriate amount of a CPU resource can be allocated to execution of the interrupting process in accordance with its contents to favorably execute respective processes.

Incidentally, the present invention can be applied to PDAs (Personal Digital Assistants), personal computers, mobile game machines, mobile music reproducers, mobile animated image reproducers and other mobile apparatuses with single CPUs, in addition to mobile phones.

A series of processes which have been described in the embodiment of the present invention can be executed by either software or hardware.

What is claimed is:

1. A mobile apparatus comprising:
a single CPU configured to execute an animating process at least including reproduction and recording of animated images in parallel with execution of a process other than the animating process; and
a resource control unit configured to control a rate of occupation of a resource of the CPU allocated to execution of an interrupting process, in the case that an interruptive event occurs while the CPU is executing the animating process, and the CPU executes the interrupting process simultaneously with occurrence of the interruptive event.

2. The mobile apparatus according to claim 1, further comprising:
a judging unit configured to judge a contents of the interrupting process to be executed simultaneously with occurrence of the interruptive event if the interruptive event occurs while the CPU is executing the animating process,
wherein the resource control unit controls the rate of occupation of the CPU resource allocated to execution of the interrupting process in accordance with the contents thereof judged by the judging unit.

3. The mobile apparatus according to claim 2, further comprising:
a storage unit configured to store information on a predetermined specific process,
wherein the judging unit judges whether the interrupting process to be executed simultaneously with occurrence of the interruptive event is the specific process; and
in the case that the judging unit judges that the interrupting process is the specific process, the resource control unit controls the rate of occupation of the CPU resource allocated to execution of the interrupting process,

4. The mobile apparatus according to claim 3, wherein the specific process is a process of generating shortage of the CPU resource required for execution of the animating process in the case that the CPU executes the animating process in parallel with execution of the process other than the animating process.

5. The mobile apparatus according to claim 2, further comprising:
a receiving unit configured to receive an electronic mail from an electronic mail server; and
an urgency judging unit configured to judge whether the electronic mail received by the receiving unit is of urgency,
wherein in the case that judging unit judges that the interrupting process to be executed simultaneously with occurrence of the interruptive event is a process of receiving the electronic mail and the urgency judging unit judges that the electronic mail is of urgency, the resource control unit maintains the rate of occupation of the CPU resource allocated to execution of the electronic mail receiving process, while in the case that the urgency judging unit judges that the electronic mail is of no urgency, the resource control unit reduces the rate of occupation of the CPU resource allocated to execution of the electronic main receiving process.

6. The mobile apparatus according to claim 2, further comprising:
a receiving unit configured to receive an electronic mail from an electronic mail server; and
a capacity value judging unit configured to judge whether a capacity value of the body of the electronic mail received by the receiving unit exceeds a predetermined specified value,
wherein in the case that the judging unit judges that the interrupting process is a process of receiving the electronic mail and the capacity value judging unit judges that the capacity value of the body of the electronic mail exceeds the predetermined specified value, the resource control unit reduces the rate of occupation of the CPU resource allocated to execution of the electronic mail receiving process.

7. The mobile apparatus according to claim 6, further comprising:
an attachment judging unit configured to judge whether the electronic mail received by the receiving unit has an attached file,
wherein in the case that the judging unit judges that the interrupting process is the electronic mail receiving process and the attachment judging unit judges that the electronic mail has the attached file, the receiving unit executes a process of receiving the attached file at the completion of the animating process.

8. The mobile apparatus according to claim 1, wherein the resource control unit controls the rate of occupation of the CPU resource allocated to execution of the interrupting process in accordance with a timing at which the CPU executes the animating process.

9. The mobile apparatus according to claim 1, wherein in the case that the interrupting process is being continuously executed at the completion of the animating process, the resource control unit completes controlling to reduce the rate of occupation of the CPU resource allocated to execution of the interrupting process.

10. A method of controlling a rate of occupation of a resource of a CPU, comprising the steps of:
preparing a single CPU configured to execute an animating process at least including reproduction and recording of animated images in parallel with execution of a process other than the animating process; and
controlling the rate of occupation of the resource of the CPU allocated to execution of an interrupting process in the case that an interruptive event occurs while the CPU is executing the animating process, and the CPU executes the interrupting process simultaneously with occurrence of the interruptive event.

11. The method of claim 10, further comprising the step of:
judging a contents of the interrupting process to be executed simultaneously with occurrence of the interruptive event if the interruptive event occurs while the CPU is executing the animating process,
wherein the step of controlling comprises: controlling the rate of occupation of the CPU resource allocated to execution of the interrupting process in accordance with the contents of the interrupting process.

12. The method of claim 11, further comprising the step of:
storing information on a predetermined specific process,
wherein the step of judging comprises: judging whether the interrupting process to be executed simultaneously with occurrence of the interruptive event is the specific process; and
controlling comprises: controlling the rate of occupation of the CPU resource allocated to execution of the interrupting process in the case of judging that the interrupting process is the specific process.

13. The method of claim 12, wherein the specific process comprises a process of generating shortage of the CPU resource required for execution of the animating process in the case that the CPU executes the animating process in parallel with execution of the process other than the animating process.

14. The method of claim 11, further comprising the steps of:
preparing a mobile apparatus including a receiving unit configured to receive an electronic mail from an electronic mail server; and
judging whether the electronic mail received by the receiving unit is of urgency,
wherein the step of controlling comprises: in the case of judging that the contents of the interrupting process to be executed simultaneously with occurrence of the interruptive event is a process of receiving the electronic mail and judging that the electronic mail is of urgency, maintaining the rate of occupation of the CPU resource allocated to execution of the electronic mail receiving process, while in the case of judging that the electronic mail is of no urgency, reducing the rate of occupation of the CPU resource allocated to execution of the electronic main receiving process.

15. The method of claim 11, further comprising the steps of:
preparing a mobile apparatus including a receiving unit configured to receive an electronic mail from an electronic mail server; and
judging whether a capacity value of the body of the electronic mail received by the receiving unit exceeds a predetermined specified value,
wherein the step of controlling comprises: in the case of judging that the contents of the interrupting process is a process of receiving the electronic mail and judging that the capacity value of the body of the electronic mail exceeds the predetermined specified value, reducing the rate of occupation of the CPU resource allocated to execution of the electronic mail receiving process.

16. The method of claim 15, further comprising the step of:
judging whether the electronic mail received by the receiving unit has an attached file,
wherein the step of receiving comprises: in the case of judging that the contents of the interrupting process is the electronic mail receiving process and judging that the electronic mail has the attached file, executing a process of receiving the attached file at the completion of the animating process.

17. The method of claim 10, wherein the step of controlling comprises: controlling the rate of occupation of the CPU resource allocated to execution of the interrupting process in accordance with a timing at which the CPU executes the animating process.

18. The method of claim 10, wherein the step of controlling comprises: in the case that the interrupting process is being continuously executed at the completion of the animating process, completing controlling to reduce the rate of occupation of the CPU resource allocated to execution of the interrupting process.
